(19) United States
(12) Patent Application Publication
(10) Pub. No.: US 2008/0203261 A1
(43) Pub. Date: Aug. 28, 2008

(54) BARN DOOR ROLLER/ADJUSTMENT

(75) Inventor: WILLIAM (Rick) F. MEYER, Milledgeville, IL (US)

Correspondence Address: MCKEE, VOORHEES & SEASE, P.L.C., 801 GRAND AVENUE, SUITE 3200, DES MOINES, IA, 50309-2721, US

(73) Assignee: MWI COMPONENTS, Spencer, IA (US)

(21) Appl. No.: 11/678,893

(22) Filed: Feb. 26, 2007

(51) Int. Cl. E05F 7/06

(52) U.S. Cl. 248/324

(57) ABSTRACT

An adjustable door hanger bolt assembly for tubular tracks that uses a wheel trolley truck assembly that has a pair of rollers in a wheel trolley frame and a hanger bolt assembly hanging down from the trolley frame within an adjustment device. Preferably, the adjustment device is an adjustment bolt from the front to move the hanger bolt towards or away from the building to accommodate for variability in building framing so that a hung door, for example a barn door, can close tightly and be bird and critter proof.

### FIELD OF THE INVENTION

This invention relates to an improvement in trolley hangers to allow rolling door adjustment more easily.

### BACKGROUND OF THE INVENTION

Wood or metal door frames for professional quality agricultural or commercial buildings are common place. Typically such wooden door frames are wide and use a trolley track system for opening and closing. Trolley track can be either square track or a tubular track but in any event it contains a pair of track wheels and hanging down from those wheels is the system that bolts to the door of the agricultural or commercial building to allow it to be pushed one way or another in the track to open or close the door. Such systems are known, see for example, CanonBall® bolt through trolley hangers sold by a Division of National Material of Michigan Limited Partnership of Beloit, Wis., a brochure of their door track is being filed with the invention disclosure statement.

One problem with door track systems is that there are wide variations in door frames for buildings of this type and as such the system must be adjusted in order to allow the door to correctly hang vertically and close against the building so that it forms an effective seal making the door bird proof, critter proof, and generally more effective to keep away from inside of the building the outdoor environment.

The industry standard for this door adjustment is a dog legged hanging bolt, as represented by the system sold by CanonBall®. The dog legged hanging bolt has a generally right angle bend in the hanging bolt which may then be twisted right or left to provide some lateral adjustment in comparison with the trolley track. While this adjustment has been the standard and used in the past, it is awkward, and sometimes difficult to institute the twisting action after the door has been installed. A bolt moving carriage or block has been used in the past, but only for square tracks. And usually makers of square track don't look to round track (and visa-versa) to solve problems since they often compete with each other for business. There is a need for a simpler more widely useable and user friendly door adjustment system which can be quickly adjusted once the door is completely hung. This invention has as its object the provision of a new easily laterally adjustable trolley system which does not rely upon a dog leg hanging bolt, or the twisting of a tang after installation in order to make adjustments.

The method of accomplishing this primary objective as well as others will become apparent from the detailed description of the preferred embodiment which follows.

### BRIEF SUMMARY OF THE INVENTION

An adjustable door hanger bolt assembly for tubular tracks that uses a wheel trolley truck assembly that has a pair of rollers in a wheel trolley frame and a hanger bolt assembly hanging down from the trolley frame within an adjustment device, i.e., moveable block or carriage. Preferably, the adjustment device is an adjustment bolt from the front to move the hanger bolt towards or away from the building to accommodate for variability in building framing so that a hung door, for example a barn door, can close tightly and be bird and critter proof.

### BRIEF DESCRIPTION OF THE DRAWINGS

FIG. 1 is a typical barn and door showing where the hanger assembly is normally in place on a typical barn door.

FIG. 2 is a perspective view of the adjustable door hanger bolt assembly.

FIG. 3 is a side view of the device shown in FIG. 1 showing the adjustable bolt detail.

### DETAILED DESCRIPTION OF THE PREFERRED EMBODIMENT

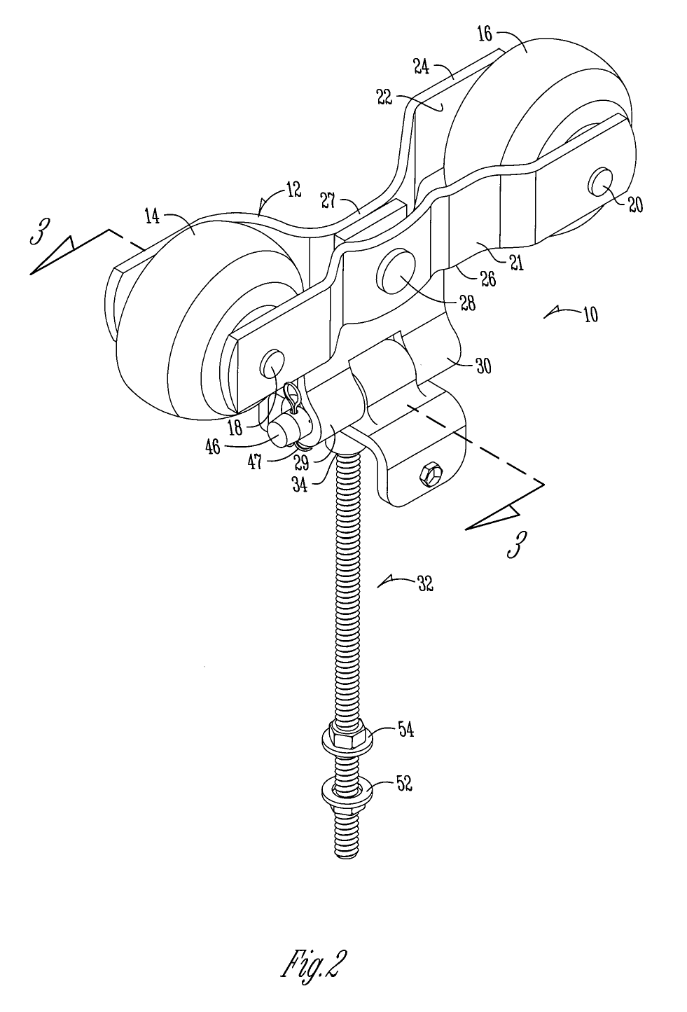

FIG. 2 shows a perspective view of the adjustable door hanger bolt assembly 10 for use with tube tracks. It is comprised of a wheel trolley truck assembly 12 having rollers 14 and 16 rotatably mounted about a horizontal axis pins 18 and 20 of wheel trolley frames 21 and 22. Frames 21 and 22 have a top portion 24, a bottom portion 26, and a central portion 27. Attached to central portion 27 of trolley frames 21 and 22 via bolt 28 are piano hinge members 29 and 30.

A hanger bolt assembly depicted generally at 32 has an upper end 34, a threaded head 35 and a lower end 36 of hanger bolt 38 which has threads 40. At the top 34 of hanger bolt 38 is bracket 42 having piano hinge member 44. Pin 46 fits through the piano hinge members 29, 30 and 44 and can be locked into place by cotter key 47 so that lower hanging bolt 38 pivots about the horizontal axis of pin 46. Hanger bolt assembly 32 has, within bracket 42, threaded adjustment bolt 48 and attaches to the top of hanger bolt 34 through threaded head or carriage 35. Thus, threaded bolt 48 can be turned to allow to and fro adjustment along its horizontal axis for hanger bolt 38 which then moves back and forth relative to the wheel track assembly 12 providing to and fro adjustment relative to wheels 14 and 16 to move a door 50 which is attached to the hanger bolt assembly 32 via washer bolts 52 and bolt 54 either in or out.

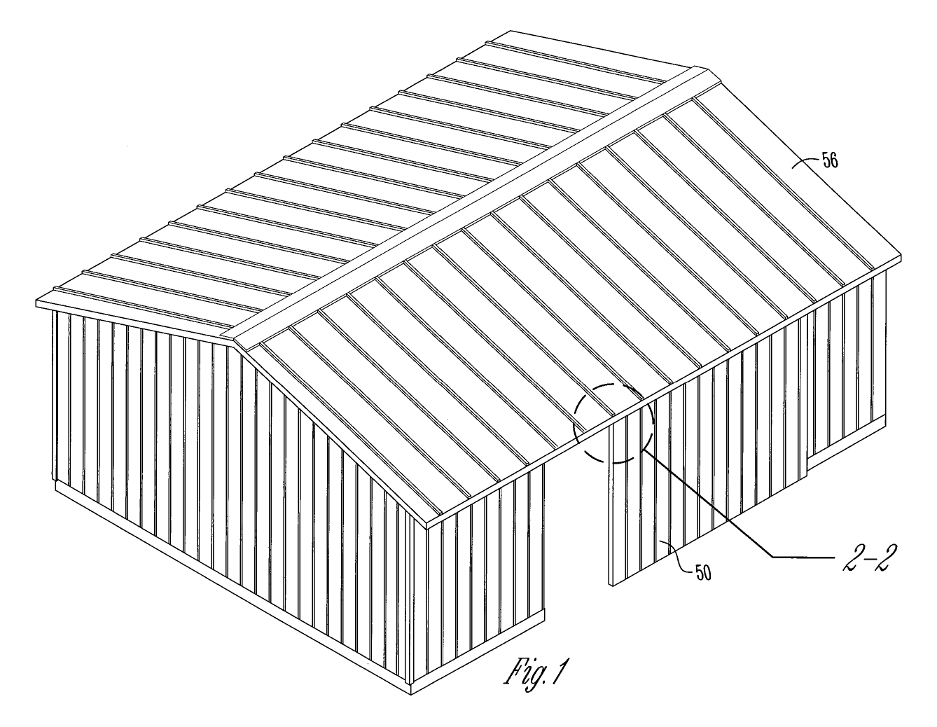

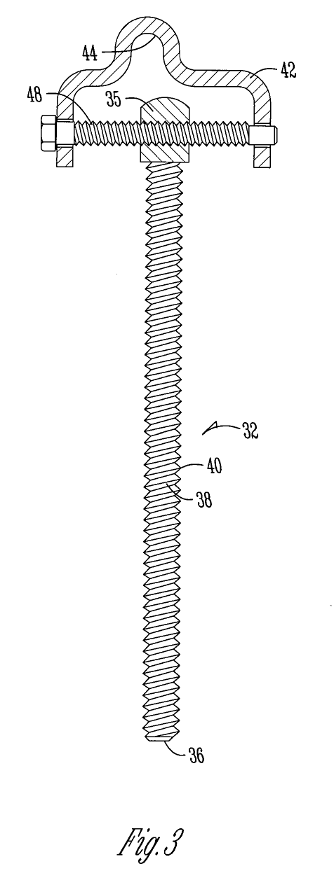

FIG. 3 shows how the adjustable door hanger bolt assembly 10 will work to adjust the door 50 of barn 56 (FIG. 1), in location on a tube track. In operation, the hanger bolt assembly 32, secured with washer nuts and lock nuts 52 and 54 to barn door 50. When the wheel trolley truck assembly 10 is mounted to the tube track (not depicted), one observes how the door 50 hangs with respect to the building frame. If the door needs to move in or out in order to be secure for bird proofing and critter proofing, adjustable bolt 48 is turned one way or another depending whether you want to move the door in or out. In this way, the door is secured, and the adjustment is easily accomplished without any need to adjust the orientation of the hanging bolt 38 by, for example, twisting a dog leg hanging bolt.

It goes without saying that this assembly can work with various trolley wheels. The rollers 14 and 16 can be steel rollers or can be hardened thermoplastic resin rollers such as acetal resins like the ones sold with the brand name Delrin®.

From the above description, it can be seen that the invention accomplishes all of its stated objectives. It further goes without saying that certain minor modifications can be made to instill, within the spirit and scope of the invention.

What is claimed is:

1. An adjustable door hanger bolt assembly comprising:
a wheel trolley truck assembly for tube tracks having a set of top rollers and a wheel trolley frame with a top and bottom for hanging in a trolley trench;
a hanger bolt assembly having an upper end and a lower end attached to the bottom of the wheel trolley frame; and
said hanger bolt assembly having an adjustment device to adjust the position of the hanger bolt towards or away from a door to which said hanger bolt is to be attached.

2. The adjustable door hanger bolt assembly of claim 1 wherein the adjustment device is a bolt adjustment.

3. The adjustable door hanger bolt assembly of claim 2 wherein the lower end of the hanger belt assembly has a means for securing it to a barn door.

4. The adjustable door assembly of claim 3 wherein the means for securing to a barn door is a washer nut and locknut.

5. The adjustable door hanger bolt assembly of claim 3 wherein the top rollers are steel tubular track rollers.

6. The adjustable door hanger bolt assembly of claim 1 wherein the top rollers are thermoplastic tubular track rollers.

7. The adjustable door hanger bolt assembly of claim 1 wherein the track assembly frame with a top and bottom, includes a hanger bolt bracket attached to the frame bottom, and said hanger bolt assembly is attached to said frame bracket.

8. The adjustable door hanger bolt assembly of claim 6 wherein said bracket is pivotally attached to the top roller frame for pivot about a horizontal axis.

9. The adjustable door hanger bolt assembly of claim 6 wherein the hanger bolt assembly is pivotally attached to said bracket for pivot about a horizontal axis, transverse to the hanger bolt axis.

10. The adjustable bolt hanger assembly of claim 1 wherein rollers are steel rollers.

11. The adjustable bolt hanger assembly of claim 1 wherein the rollers are a hardened thermo-plastic resin.

12. The adjustable bolt hanger of claim 11 wherein the rollers are acetal resin.
